(19) United States
(12) Patent Application Publication
(10) Pub. No.: US 2016/0154553 A1
(43) Pub. Date: Jun. 2, 2016

(54) METHOD AND SYSTEM FOR TERM OCCURRENCE PAGINATION INTERFACE

(71) Applicant: Kobo Incorporated, Toronto (CA)

(72) Inventor: Inae HEO, North York (CA)

(73) Assignee: KOBO INCORPORATED, Toronto (CA)

(21) Appl. No.: 14/558,216

(22) Filed: Dec. 2, 2014

(51) Int. Cl. G06F 3/0483; G06F 17/21; G06F 3/0488

(52) U.S. Cl. CPC G06F 3/0483; G06F 3/04883; G06F 17/217

(57) ABSTRACT

A method and system for providing a term-occurrence pagination interface white reading digital content (e-reading) on a computer device having a touchscreen display The method comprises receiving a term occurrence search request at a text portion of the e-book content, the text portion comprising the term; rendering a term occurrence first page from the sequence of pages of e-book content at a first portion of the display screen, the term occurrence first page being repaginated to fit within the first portion of the display screen; presenting a term occurrence pagination interface at a second portion of the display screen; receiving, at the term occurrence interface, a navigation request for transitioning to an term occurrence adjacent page of the sequence of pages of e-book content and repaginating the term occurrence adjacent page within the sequence of pages of e-book content for display replacement of the term occurrence first page at the first portion of the display screen.

### TECHNICAL FIELD

Examples described herein relate to a system and method for operating a computing device in providing a term occurrence pagination interface for digital reading (e-reading).

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple Phone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the frill benefit and functionality of the device.

Yet further, such devices may incorporate a touch screen display having integrated touch sensors and touch sensing functionality, whereby user input commands via touch-based gestures are received thereon.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device configured for operation in providing a term-occurrence pagination interface for reading digital content (e-reading), in an embodiment.

FIG. 2 illustrates a schematic architecture and configuration of a computing device configured for providing a term-occurrence pagination interface for digital content (e-reading) displayed on a touchscreen display of the computing device, according to an embodiment.

FIG. 3 illustrates an example configuration for a term-occurrence pagination interface for reading digital content (e-reading) on a computer device having a touchscreen display, according to an embodiment.

FIG. 4 illustrates a method for providing a term-occurrence pagination interface for e-reading on a computer device having a touchscreen display, according to an embodiment.

### DETAILED DESCRIPTION

“E-books” are a form of electronic publication content stored in digital format in a computer non-transitory memory, viewable on a computing device having display functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-book. By way of example, an e-reading device can include a mobile computing device on which an c-reading application can be executed to render content that includes e-books (e.g., comic books, magazines, etc.). Such mobile computing devices can include, tier example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

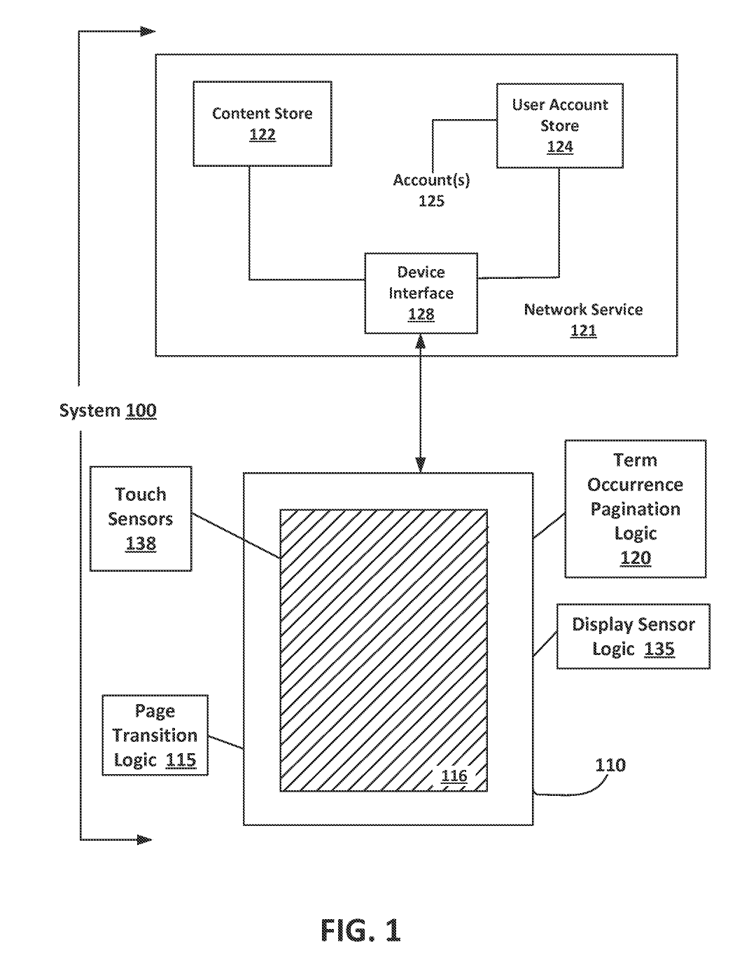

FIG. 1 illustrates a system 100 for utilizing applications and providing c-book services on a computing device, according to an embodiment. In an example of FIG. 1, system 100 includes an electronic personal display device, shown by way of example as an e-reading device 110, and a network service 121. The network service 121 can include multiple servers and other computing resources that provide various services in connection with one or more applications that are installed on the e-reading device 110. By way of example, in one implementation, the network service 121 can provide e-book services that communicate with the e-reading device 110. The e-book services provided through network service 121 can, for example, include services in which e-books are sold, shared, downloaded and/or stored. More generally, the network service 121 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or telephony/messaging device (e.g., smart phone). In one implementation, for example, e-reading device 110 can run an e-reader application that links the device to the network service 121 and enables e-books provided through the service to be viewed and consumed. In another implementation, the e-reading device 110 can run a media playback or streaming application that receives files or streaming data from the network service 121. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 121 can include a device interface 128, a content store 122 and a user account store 124. The user account store 124 can associate the e-reading device 110 with a user and with an account 125. The account 125 can also be associated with one or more application resources (e.g., e-books), which can be stored in the content store 122. The device interface 128 can handle requests from the e-reading device 110, and further also requests of e-reading device 110 with regard to services and functionality of the network service 121. The device interface 128 can utilize information provided with a user account 125 in order to enable services, such as purchasing downloads or determining what e-books and content items are associated with e-reading device 110. Additionally, the device interface 128 can provide the e-reading device 110 with access to the content store 122, which can include, for example, an online store. The device interface 128 can handle input to identify content items (e.g., e-books), and further to link content items to the account 125 of the user.

Yet further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on a particular computing device.

With reference to an example of FIG. 1, e-reading device 110 can include a display 116. In an embodiment, the display 116 is touch-sensitive, to process touch inputs including gestures (e.g., swipes). For example, the display 116 may be integrated with one or more touch sensor components 138 to provide a touch-sensing region on a surface of the display 116. For some embodiments, the one or more touch sensor components 138 may include capacitive sensors that can sense or detect a human body's capacitance as input. In the example of FIG. 1, the touch-sensing region coincides with a substantial surface area, if not all, of the display 116. Additionally, the housing can be integrated with touch sensors to provide one or more touch sensing regions, for example, on the bezel and/or back surface of the housing.

In some embodiments, the e-reading device 110 includes features for providing functionality related to displaying paginated content, including paginated content comprising e-magazine or e-comic book. The e-reading device 110 can include page transitioning logic 115, which enables the user to transition through paginated content. The e-reading device 110 can display pages of e-books, e-magazines and e-comics, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state o another page state In the specific example embodiment where a given page state coincides with a single page, for instance, each page state corresponding to one page of the digitally constructed series of pages paginated to comprise, in one embodiment, e-book. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch-sensing region of the display 116. For example, the user may swipe the surface of the display 116 in a particular direction (e.g., up, down, left, or right) to indicate a backward or forward direction of page transition. In variations, the user can specify different kinds of page transitioning input (e.g., single page turns, multiple page turns, chapter turns, etc.) through different kinds of input. Additionally, a page turn input of the user can be provided according to a magnitude of the input action indicate a corresponding magnitude (number of pages) for the transition of the page state. For example, a user can touch and hold the surface of the display 116 in order to cause a cluster or chapter page state transition, while a tap in the same region can only effect a single page state transition (e.g., from one page to the next in sequence). In another example, a user can specify page turns of different kinds or magnitudes through single taps, sequenced taps or patterned taps on the touch sensing region of the display 116. Although discussed in context of “taps” herein, it is contemplated that a gesture action provided in sufficient proximity to touch sensors of display 116, without physically touching thereon, may also register as a “contact” with display 116, to accomplish a similar effect as a tap, and such embodiments are also encompassed by the description herein.

According to some embodiments, the e-reading device 110 includes display sensor logic 135 to detect and interpret user input or user input commands made through interaction with the touch sensor components 138. By way of example, display sensor logic 135 can detect a user making contact with the touch-sensing region of the display 116, otherwise known as a touch event. More specifically, display sensor logic 135 can detect a touch events also referred to herein as a tap, an initial tap held in contact with display 116 for longer than some pre-defined threshold duration of time (otherwise known as a “long press” or a “long touch”), multiple taps performed either sequentially or generally simultaneously, swiping gesture actions made through user interaction with the touch sensing region of the display 116, or any combination of these gesture actions. Although referred to herein as a “touch” or a tap, it should be appreciated that in some design implementations, sufficient proximity to the screen surface, even without actual physical contact, may register a “contact” or a “touch event”. Furthermore, display sensor logic 135 can interpret such interactions in a variety of ways. For example, each such interaction may be interpreted as a particular type of user input associated with a respective input command, execution of which may trigger a change in state of display 116.

In one implementation, display sensor logic 135 implements operations to monitor for the user contacting or superimposing upon, using a finger, thumb or stylus, a surface of display 116 coinciding with a placement of one or more touch sensor components 138, that is, a touch event, and also detects and correlates a particular gesture (e.g., pinching, swiping, tapping, etc.) as a particular type of input or user action. Display sensor logic 135 may also sense directionality of a user gesture action so as to distinguish between, for example, leftward, rightward, upward, downward and diagonal swipes along a surface portion of display 116 for the purpose of associating respective input commands therewith.

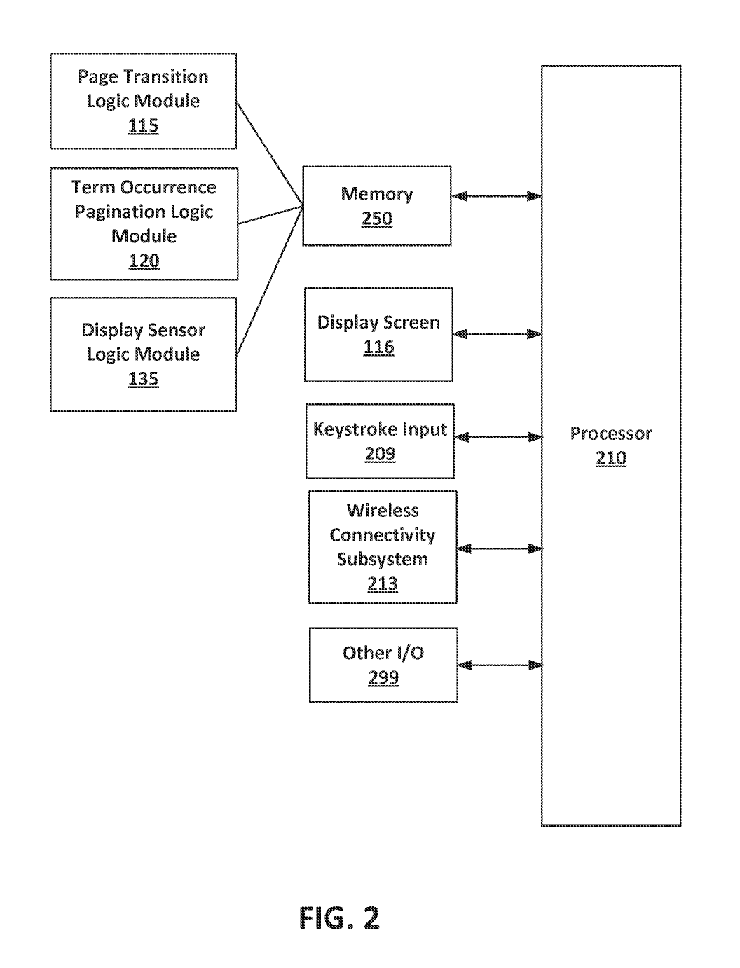

Term occurrence pagination module 120 can be implemented as a software module comprising instructions stored in a memory of e-reading device 110, as described in further detail below with regard to FIG. 2.

One or more embodiments of term occurrence pagination module 120, display sensor logic 135 and page transition logic 115 described herein may be implemented using programmatic modules or components. A programmatic module or component may include a program, a subroutine, a portion of a program, or software or a hardware component capable of performing one or more stated tasks or functions in conjunction with one or more processors. As used herein, a module or component can exist on a hardware component independently of other modules or components. Alternatively, a module or component can be a shared element or process of other modules, programs and hardware components.

Furthermore, the one or more embodiments of term occurrence pagination module 120, display sensor logic 135 and page transition logic 115 described herein may be implemented through instructions that are executable by one or more processors. These instructions may be stored on a computer-readable non-transitory medium. In particular, the numerous computing and communication devices shown with embodiments of the invention include processor(s) and various forms of computer memory, including volatile and non-volatile forms, storing data and instructions. Examples of computer-readable mediums include permanent memory storage devices, such as hard drives on personal computers or servers. Other examples of computer storage mediums include portable storage units, flash or solid-state memory (such as included on many cell phones and consumer electronic devices) and magnetic memory. Computers, terminals, network enabled devices (e.g., mobile devices such as cell phones and wearable computers) are all examples of machines and devices that utilize processors, memory, and instructions stored on computer-readable mediums. Additionally, embodiments may be implemented in the form of computer-programs, or a computer usable storage medium capable of storing such a program.

FIG. 2 illustrates a schematic architecture and configuration of a computing device configured for providing a term-occurrence pagination interface for digital content (e-reading displayed on a touchscreen display of the computing device, according to an embodiment.

E-reading device 110 further includes processor 210, a memory 250 storing instructions and logic pertaining at least to display sensor logic 135, term occurrence pagination module 120, and page transition logic 115.

Processor 210 can implement functionality using the logic and instructions stored in memory 250. Additionally, in some implementations, processor 210 communicates with the network service 121 (see FIG. 1). More specifically, the e-reading device 110 can access the network service 121 to receive various kinds of resources (e.g., digital content items such as e-books, configuration files, account information), as well as to provide information (e.g., user account information, service requests etc.). For example, e-reading device 110 can receive application resources, such as e-books or media files, that the user elects to purchase or otherwise download via the network service 121. The application resources that are downloaded onto the e-reading device 110 can be stored in memory 250.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components 138 may be integrated with display 116. In other embodiments, the touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can receive input from various sources, including touch sensor components 138, display 116, keystroke input 208 such as from a virtual or rendered keyboard, and other input mechanisms 299 (e.g., buttons, mouse, microphone, etc.). With reference to examples described herein, processor 210 can respond to input detected at the touch sensor components 138. In some embodiments, processor 210 responds to inputs from the touch sensor components 138 in order to facilitate or enhance e-book activities such as generating e-book content on display 116, performing page transitions of the displayed e-book content, powering off the e-reading device 110 and/or display 116, activating a screen saver, launching or closing an application, and/or otherwise altering a state of display 116.

In some embodiments, memory 250 may store display sensor logic 135 that monitors for user interactions detected through the touch sensor components 138, and further processes the user interactions as a particular input or type of input. In an alternative embodiment, display sensor logic 135 may be integrated with the touch sensor components 138. For example, the touch sensor components 138 can be provided as a modular component that includes integrated circuits or other hardware logic, and such resources can provide some or of display sensor logic 135. In variations, some or all of display sensor logic 135 may be implemented with processor 210 (which utilizes instructions stored in memory 250), or with an alternative processing resource.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which e-reading device 110 is intended to operate, such as in accordance with Wi-Fi, Bluetooth, Near Field Communication (NFC) communication protocols, and the like.

Term occurrence pagination module 120, in one embodiment, enables a user to locate occurrences of any given term in the digital content comprising the e-book, among other functions as described below. A corresponding term search operation with regard to a conventional paper book or textbook may be initiated at an index section, typically located towards the end of the work, whereupon a user searches terms alphabetically, notes the term occurrence page numbers, then flips pages to view each page individually. The digital structure of an e-book, wherein pages are constructed of digitally stored text, may allow manipulation of e-book text terms comprising the content in other ways, however. The term “pagination” or “repagination” as used herein refers not only to numbering of pages in the conventional sense, but more particularly, the process of re-structuring or re-constructing digital pages by reflowing, or line-wrapping, an ending text portion of a given page onto a next page in the ordered sequence of digitally constructed pages comprising an e-book. In this manner, repaginated may be accomplished by reflowing lines of text content from an ending portion of content in a given page onto a beginning portion of a next page view, white maintaining text attributes such as font size, text spacing, word spacing, etc. for continuity in appearance and reading experience by an observer.

Term occurrence pagination module 120 can be implemented as a software module, comprising instructions stored in memory 250, on e-reading device 110. One or more embodiments of term occurrence pagination module 120 described herein may be implemented using programmatic modules or components, a portion of a program, or software in conjunction with one or more hardware component(s) capable of performing one or more stated tasks or functions. As used herein, such module or component can exist on a hardware component independently of other modules or components. Alternatively, a module or component can be a shared element or process of other modules, programs or machines.

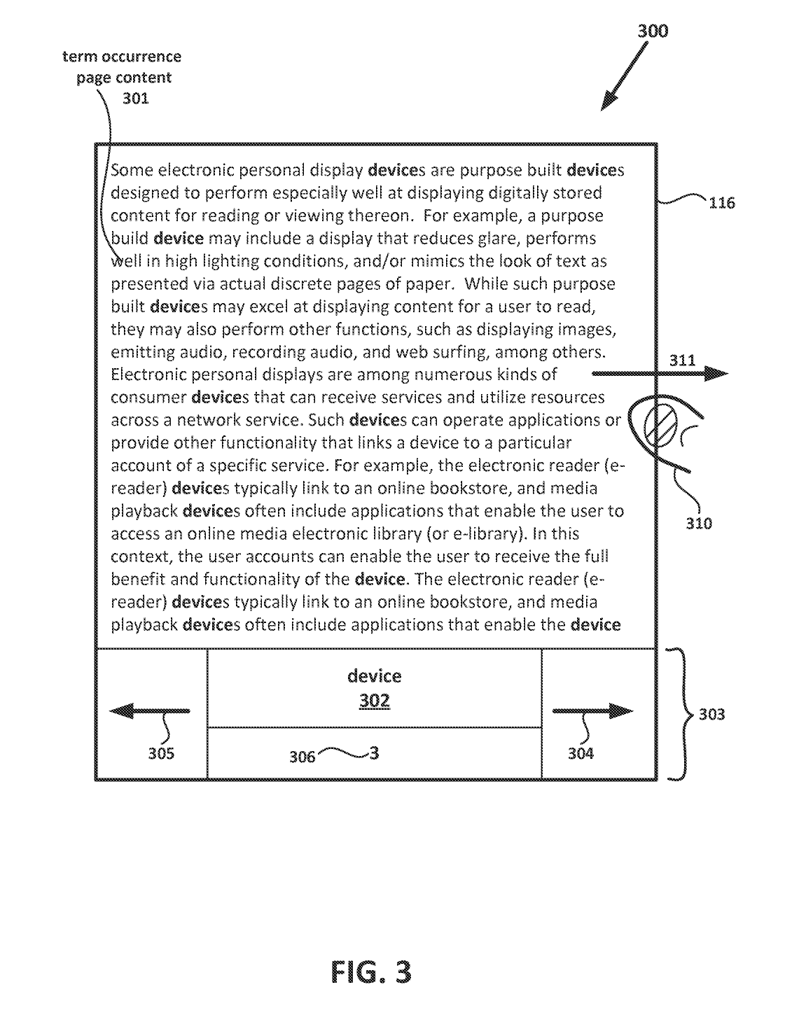

FIG. 3 illustrates an example embodiment for a term-occurrence pagination interface in view 300 during reading of e-book content (e-reading) on a computer device having a touchscreen display, particularly in regard to operation of term occurrence pagination module 120.

In prelude to the depiction of FIG. 3, and with regard to content of a page in the ordered sequence of pages comprising an e-book, a search request may be initiated by selection of any text term at any given page, including but not limited to an index page. In one embodiment, a touch action or gesture may he received at the term, such as a long press, a term highlighting action, a swipe action upon the term, a page advance action, a page backward action and the like.

FIG. 3 shows term occurrence page content 301, representing a term occurrence first page at which the term “device” was selected for a comprehensive search across the paginated content of the e-book. Notably, the original page of the e-book in memory 250 is repaginated, whereby less than a full portion portion of that original page is repaginated as term occurrence page content 301 for fit into a first portion of display 116, thereby to accommodate rendering of term occurrence pagination interface 303 at a second portion of the display screen.

Still with reference to FIG. 3, the searched term “device” may be rendered within term occurrence page content 301 in visually distinct manner from other content therein, such as bold or italics typeface, color, or via highlighting or variation in illumination, in some embodiments. Searched term 302, e.g., “device”, may be rendered within term occurrence pagination interface 303. In another embodiment, a user may specify a threshold number of term occurrences 306 upon which the search may be based. In the example embodiment depicted in FIG. 3, the threshold number of term occurrences 306 is selected as “3”, so only occurrence pages which include 3 or more occurrences of the term “device” will be located and shown in view 300.

Again with reference to FIG. 3, term occurrence pagination interface 303 may further include term occurrence forward navigation input selector 304 and term occurrence backward input selector 305 in order to enact, at the term occurrence pagination interface 303, a navigation request for transitioning to a term occurrence adjacent page in the ordered sequence of pages of e-book content. By way of example and instance, touching either of forward navigation input selector 304 or term occurrence backward input selector 305 presented at a touchscreen type display 116 of e-reading device 110 allows transition to the rendered term occurrence adjacent page, which is presented, albeit in repaginated form, in replacement of the term occurrence page content 301 view upon display 116.

Notably, and still with reference to FIG. 3, upon display of any term 302 occurrence page at 116, for purposes of e-reading context, a user may choose to page transition, whether backwards or forwards, to a next page of the e-book content, regardless of whether such page contains any occurrences of the searched term 302 or not. The page transition action, in an embodiment, may be enacted via a user's digit or stylus 310 swiped along direction 311 to trigger a forward page turn, in the embodiment depicted in FIG. 3.

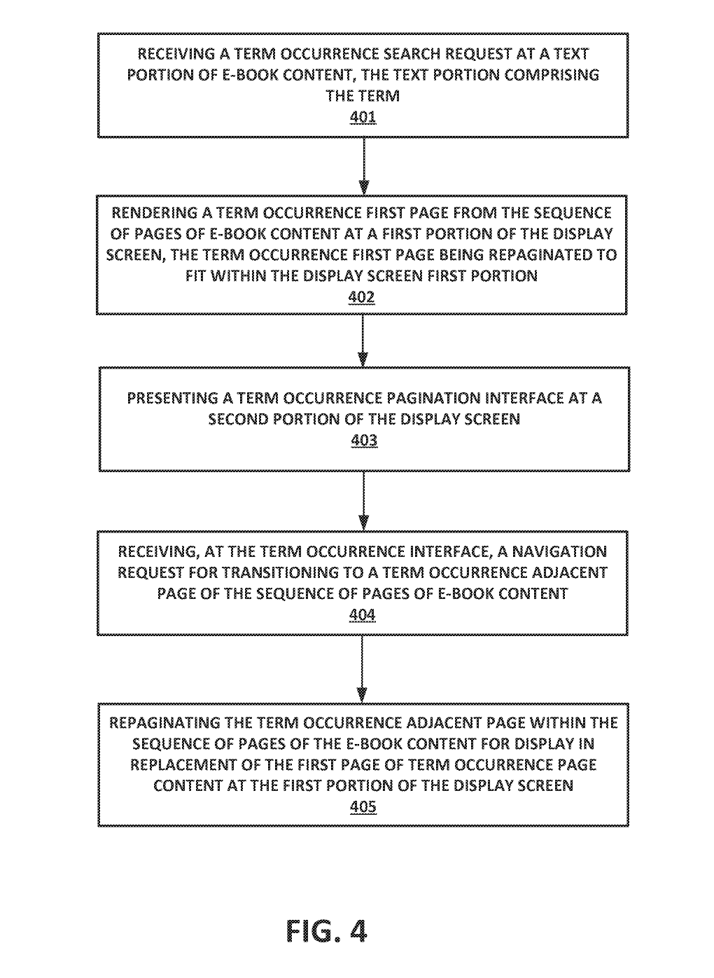

Next with reference to FIG. 4, illustrated is a method for providing a term-occurrence pagination interface for e-reading on e-reading device 110 having touchscreen type display 116, according to an embodiment. In describing the example of FIG. 4, reference will be made to components such as described with regard to FIGS. 1 through 3 for purposes of illustrating components for performing a step or sub-step as described.

At step 401, receiving a term occurrence search request at a text portion of the e-book content rendered upon display 116 of e-reading device 110, the text portion comprising the term 302 “device”.

At step 402, rendering a first page of term occurrence page content 301 from the sequence of pages of e-book content at a first portion of the display 116, the first page term occurrence page content 301 being repaginated to fit within the first portion of display 116.

At step 403, presenting a term occurrence pagination interface 303 at a second portion of display 116.

At step 404, receiving, at the term occurrence pagination interface 303, a navigation request for transitioning to a term occurrence adjacent page of the sequence of pages of e-book content. For example, the navigation request may be performed by selecting forward navigation input selector 304 or term occurrence backward input selector 305.

At step 405, repaginating the term occurrence adjacent page within the sequence of pages of the e-book content for display in replacement of the first page of term occurrence page content 301 at the first portion of the display screen.

Although illustrative embodiments have been described in detail herein with reference to the accompanying drawings, variations to specific embodiments and details are contemplated and encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method executed in a processor of a computing device, the computing device further including a memory storing instructions and a display screen having touch functionality, the display screen rendering an e-book content including text formatted in a sequence of digitally constructed pages, the method comprising:
receiving a term occurrence search request at a text portion of the e-book content, the text portion comprising the term;
rendering a term occurrence first page from a sequence of pages of e-book content at a first portion of the display screen, the term occurrence first page being repaginated to fit within the first portion of the display screen;
presenting a term occurrence pagination interface at a second portion of the display screen;
receiving, at the term occurrence interface, a navigation request for transitioning to a term occurrence adjacent page of the sequence of pages of e-book content; and
repaginating the term occurrence adjacent page within the sequence of pages of e-book content for display in replacement of the term occurrence first page at the first portion of the display screen.

2. The method of claim 1 wherein the repaginating comprises reflowing an ending text portion of a page of the sequence of digitally constructed pages onto a next page.

3. The method of claim 1 wherein the navigation request comprises a touch action received at the term occurrence interface.

4. The method of claim 1 wherein the navigation request comprises a swipe action received at the term occurrence interface.

5. The method of claim 1 wherein the term occurrence search request is received by way of a long press upon the term.

6. The method of claim 1 wherein the term occurrence search request is received by way of a highlighting action performed upon the term.

7. The method of claim 1 further comprising receiving a page transition action performed at the first portion of the display screen.

8. The method of claim 7 wherein the page transition action received at the first portion of the display screen is one of a page advance action and a page backward action.

9. The method of claim 1 further comprising receiving a threshold number of term occurrences for rendering the term occurrence adjacent page.

10. The method of claim 1 wherein the term is rendered visually distinctly within the term occurrence first page at the first portion of the display screen.

11. A computer-readable medium that stores instructions for a computing device, the computing device including a processor, a memory and a display screen having touch functionality, the display screen rendering an e-book content including text formatted in a sequence of digitally constructed pages, the instructions being executable by the processor to cause the computing device to perform operations that include:
receiving a term occurrence search request at a text portion of the e-book content, the text portion comprising the term;
rendering a term occurrence first page from a sequence of pages of e-book content at a first portion of the display screen, the term occurrence first page being repaginated to fit within the first portion of the display screen;
presenting a term occurrence pagination interface at a second portion of the display screen;
receiving, at the term occurrence interface, a navigation request for transitioning to a term occurrence adjacent page of the sequence of pages of e-book content; and
repaginating the term occurrence adjacent page within the sequence of pages of the e-book content for display in replacement of the term occurrence first page at the first portion of the display screen.

12. A computing device comprising:
a memory that stores a set of instructions;
a display screen having touch functionality;
a processor that access the instructions in memory, the processor further configured to:
receive a term occurrence search request at a text portion of an e-book content, the text portion comprising the term, e-book content including text formatted in a sequence of digitally constructed pages;
render a term occurrence first page from a sequence of pages of e-book content at a first portion of the display screen, the term occurrence first page being repaginated to fit within the first portion of the display screen;
present a term occurrence pagination interface at a second portion of the display screen;
receive, at the term occurrence interface, a navigation request for transitioning to a term occurrence adjacent page of the sequence of pages of e-book content; and
repaginate the term occurrence adjacent page within the sequence of pages of e-book content for display in replacement of the term occurrence first page at the first portion of the display screen.

13. The computing device of claim 12 wherein the repaginating comprises reflowing an ending text portion of a page of the sequence of digitally constructed pages onto a next page.

14. The computing device of claim 12 wherein the navigation request comprises a ouch action received at the term occurrence interface.

15. The computing device of claim 12 wherein the navigation request comprises a swipe action received at the term occurrence interface.

16. The computing device of claim 12 wherein the term occurrence search request is received by way of a long press upon the term.

17. The computing device of claim 12 wherein the term occurrence search request is received by way of a highlighting action performed upon the term.

18. The computing device of claim 12 further comprising receiving a page transition action performed at the first portion of the display screen.

19. The computing device of claim 18 wherein the page transition action received at the first portion of the display screen is one of a page advance action and a page backward action.

20. The computing device of claim 12 further comprising receiving a threshold number of term occurrences fur rendering the term occurrence adjacent page.
